(19) United States
(12) Patent Application Publication
(10) Pub. No.: US 2006/0209440 A1
(43) Pub. Date: Sep. 21, 2006

(54) Color wheel for micro-device projection display

(75) Inventors: Kyung Geun Bang, Suwon (KR); Ha Min Jung, Suwon (KR); Dong O Lim, Suwon (KR); Sang Hwan Park, Suwon (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/319,384

(22) Filed: Dec. 29, 2005

(30) Foreign Application Priority Data
Mar. 16, 2005 (KR) 10-2005-0021717

(51) Int. Cl. G03B 21/14

(52) U.S. Cl. 359/892

(57) ABSTRACT

The invention provides a color wheel for Micro-Device (MD) projection display. The color wheel of the invention includes a color filter with different colors divided on the circumference thereof, a driving motor rotating a rotor with the color filter assembled thereinto, and a filter adhesion layer fixing the color filter to the carrier by an adhesive applied on the overlapping region of the carrier and the color filter. The color wheel also includes a holder having a fixing part to maintain compressive stress offsetting tensile stress generated at the filter adhesion layer. The invention minimizes tensile stress at the adhesion part for fixing the color filter, increasing the adhesive force between the adherent and the adhesive, thereby allowing firm fixing of the color filter to the driving motor without using an adhesive.

### CLAIM OF PRIORITY

This application claims the benefit of Korean Patent Application No. 2005-21717 filed on Mar. 16, 2005, in the Korean Intellectual Property Office, the disclosure of which is incorporated herein by reference.

### BACKGROUND OF THE INVENTION

1. Field of the Invention

The present invention relates to a color wheel used in Micro-Device (MD) projection display such as Digital Light Processing (DLP), Liquid Crystal Display (LCD) or Liquid Crystal on Silicon (LCOS). More particularly, the present invention relates to a color wheel for MD projection display which minimizes tensile stress at an adhesion part for fixing a color filter by an adhesive, thereby increasing the adhesion force between the adherent and the adhesive, and also which can firmly fix the color filter to the driving motor without using an adhesive.

2. Description of the Related Art

In general, Micro-Device (MD) projection display refers to an entire projection system, which realizes clear large-sized color picture using a small chip, for example, Digital Light Processing (DLP), Liquid Crystal Display (LCD), or Liquid Crystal on Silicon (LCOS).

As shown in FIG. 1, an MD projection display system includes a lamp 10 for a light source, a condensing lens 20 for condensing light from the lamp 10, a color wheel 30 for separating the white light condensed from the condensing lens 20 into red R, green G, and blue B to illuminate one third of the beam on each frame, a collimating lens 40 for irradiating the color-specific light emitted from the color wheel 30, a micro-device (MD) 50 for adjusting the reflection angle for each pixel of the color-specific light condensed from the collimating lens 40 to form a picture or selectively transmitting an image to form a picture, and/or a projection lens 60 for projecting the image formed by the MD 50 on a screen S.

In a DLP projection display system, a Digital Mirror Device (DMD) is used for the MD 50. The DMD 50 has a plurality of minute-size reflecting mirrors (not shown) on a silicon wafer in two dimensions. The reflecting mirrors convert the route of the incident light into two states (on/off) to reflect the light as they are tilted by a tilting actuator (not shown) at a high speed of 10 μS (μS is 1/1,000,000 second).

In other words, each of the reflecting mirrors is in charge of a pixel structure, controlling reflecting activity of the light to form a picture. As the reflecting mirror corresponding to a pixel is tilted by the tilting actuator in an ‘on’ state, the light reflected on the reflecting mirrors is enlarged through a projection lens 60 to be projected on the screen S. On the other hand, as the reflecting mirrors are tilted in an ‘off’ state, the light reflected on the reflecting mirrors does not exit the projection lens 60 and is not incident on the screen S.

The DMD 50 tilts each reflecting mirror provided therein independently in accordance with the image signal for each pixel to alter the reflecting angle of the light, thereby changing the state of the light to ‘on’ or ‘off’ to form the image enlarged through the projection lens 60 as a large picture on the screen S.

In the meantime, the color wheel 30, which imparts colors to the white light condensed at the condensing lens 20, includes a color filter 31 with red R, green G, and blue B colors divided on the circumference thereof, and a driving motor for providing driving source to rotate the color filter 31 at a high speed.

The color filter 31 has a surface thereof adhered to the upper surface of a hollow disc-shaped carrier 34 by an adhesive 35, and the carrier 34 with the color filter 31 fixed thereto is inserted into a rotor 33 of a driving motor 32 to be fixed in the position thereof.

Then, as shown in FIG. 2, the color filter 31 and the carrier 34 are fixed to the rotor 33 by a holder 36 with annular upper and lower protrusions 36a and 36b protruding respectively from the upper and lower surfaces of the hollow disc-shaped body thereof.

As the lower protrusion 36b of the holder 36 is fitted along the outer surface of the rotor 33, the lower edge of the lower protrusion 36b is inserted into the gap between an outer surface of the rotor and the inner end of the color filter 31, contacting an upper surface of the carrier 34. At this time, part of the upper surface of the color filter 31 comes in surface contact with the lower surface of the body of the holder 36.

The color filter 31 having one side adhered to the carrier 34 by an adhesive 35, is disposed near an optical source inside an optical engine of the MD projection display system, rotating at a high speed of maximum 10,800 rpm while being exposed to a high temperature of above 80° C. Thus, during the high-speed rotation, centrifugal force is generated at the adhesion part between the color filter 31 and the carrier 34.

Especially, as shown in FIG. 2, since the color filter 31 is adhered with one side to the carrier 34, the location of the center of the section of the color filter 31 where centrifugal force is generated does not horizontally coincide with that of the adhesive 35. Therefore, a tensile stress with a tensile force working perpendicular to the adhesion surface by the adhesive 35 and a shear stress with a shear force working horizontal to the adhesion surface are generated at the adhesion part with the adhesive 35. These tensile stress and shear stress weaken the adhesive force of the adhesive 35, thereby shortening the life time of the color wheel 30.

Accordingly in the prior art, in order to increase the intensity of adhesion force of the adhesive 35 between the color filter 31 and the carrier 34, the size of the adhesion area between the color filter 31 and the carrier 34 is increased. However, as the adhesion area becomes larger, the holder 36 becomes larger, increasing the load of the driving motor 32, thereby decreasing the effective area of the color filter 31 and imposing a limit on the design of the product.

### SUMMARY OF THE INVENTION

The present invention has been made to solve the foregoing problems of the prior art and it is therefore an object of the present invention to provide a color wheel for MD projection display which offsets or minimizes tensile stress, increasing the adhesive force between the adherent and the adhesive, thereby extending the life of the color wheel.

It is another object of the invention to provide a color wheel for MD projection display which firmly fixes a color filter to a driving motor without using an adhesive, thereby improving productivity in assembly.

According to an aspect of the invention for realizing the object, the present invention provides a color wheel for Micro-Device (MD) projection display, used in an optical engine to impart a plurality of colors to white light projected along an optical axis, including: a color filter with a plurality of colors divided on the circumference thereof; a driving motor providing driving source to rotate a rotor with the color filter assembled thereinto, about a rotational axis in parallel with the optical axis; a filter adhesion layer having an adhesive applied to an adhesion surface where a carrier assembled into the rotor overlaps with the color filter placed thereon, so as to provide adhesive force for fixing the color filter to the carrier; and a holder having a fixing part in an inner surface thereof corresponding to an outer surface of the rotor in order to maintain compressive force owing to a predetermined intensity of external force applied to the filter adhesion layer through the color filter, thereby imparting a compressive stress which offsets a tensile stress generated at the filter adhesion layer.

Preferably, the intensity of the compressive stress is set greater than the tensile stress generated at the filter adhesion layer and less than breaking strength of the color filter.

Preferably, the fixing part has a holder adhesion layer formed by an adhesive applied between an outer surface of the rotor and a corresponding inner surface of the holder.

Preferably, the fixing part is composed of a hot insertion-plate surface which is press-fitted into an outer surface of the rotor while hot so as to be fixed to an outer surface of the rotor when cooled.

Preferably, the fixing part has a caulked part extending along an outer surface of the rotor to have a large contact surface on an inner surface thereof corresponding to an outer surface of the rotor.

According to another aspect of the invention for realizing the object, the present invention provides a color wheel for Micro-Device (MD) projection display, used in an optical engine to impart a plurality of colors to white light projected along an optical axis, including: a color filter with a plurality of colors divided on the circumference thereof; a driving motor providing driving source to rotate a rotor with the color filter assembled thereinto, about a rotational axis in parallel with the optical axis; a filter adhesion layer having an adhesive applied to an adhesion surface where a carrier assembled into the rotor overlaps with the color filter placed thereon, so as to provide adhesive force for fixing the color filter to the carrier; and a holder assembled into the rotor having a holder adhesion layer provided on an interface between the holder and the color filter so as to generate a tensile stress in opposite direction to that generated between the color filter and the filter adhesion layer, thereby offsetting the tensile stresses generated at upper and lower surfaces of the color filter.

Preferably, the holder adhesion layer has an adhesion area having the same size as that of the filter adhesion layer.

Preferably, the holder adhesion layer has at least one upper groove depressed in a lower surface of the holder corresponding to an upper surface of the color filter, and an adhesive filled in the upper groove.

According to further another aspect of the invention for realizing the object, the present invention provides a color wheel for Micro-Device (MD) projection display, used in an optical engine to impart a plurality of colors to white light projected along an optical axis, including: a color filter with a plurality of colors divided on the circumference thereof; a driving motor providing driving source to rotate the rotor with the color filter assembled thereinto, about a rotational axis in parallel with the optical axis; a filter adhesion layer having an adhesive applied to an adhesion surface where a carrier assembled into the rotor overlaps with the color filter placed thereon, so as to provide adhesive force for fixing the color filter to the carrier; and at least one spring member with one end fixed to the outer surface of the rotor to apply compressive force to the filter adhesion layer through the color filter, and the other end resiliently contacting an upper surface of the color filter to provide the filter adhesion layer with compressive stress which offsets a tensile stress generated at the filter adhesion layer.

Preferably, the spring members are arranged bilaterally symmetrical about the axis of the rotor.

Preferably, the other end of the spring member is in surface contact with an upper surface of the color filter.

Preferably, the other end of the spring member is positioned within the overlapping region of the color filter and the carrier.

According to further another aspect of the invention for realizing the object, the present invention provides a color wheel for Micro-Device (MD) projection display, used in an optical engine to impart a plurality of colors to white light projected along an optical axis, including: a color filter with a plurality of colors divided on the circumference thereof; a driving motor providing driving source to rotate the rotor with the color filter assembled thereinto, about a rotational axis in parallel with the optical axis; a holder fixed to the rotor to have a lower surface thereof in contact with an upper surface of the color filter; and a friction part for fixing the color filter to the rotor, by friction force, including a lower friction material provided in an interface between the color filter and the carrier assembled into the rotor, and an upper friction material provided in an interface between the color filter and the holder.

Preferably, the upper friction material is provided in at least one upper groove depressed on a lower surface of the holder corresponding to an upper surface of the color filter, and the lower friction material is provided in at least one lower groove depressed on an upper surface of the carrier corresponding to a lower surface of the color filter.

Preferably, the upper and lower friction materials are positioned on the same horizontal line, overlapping each other vertically.

Preferably, the upper and lower friction materials are provided in the entire areas of the overlapping regions of an upper surface of the color filter and a lower surface of the holder, and of a lower surface of the color filter and an upper surface of the carrier, and preferably, the upper and lower friction materials are made of rubber.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the operation of an MD projection display system in general;

FIG. 2 is a block diagram illustrating the conventional MD projection display system of FIG. 1;

FIG. 3 is a block diagram illustrating a first embodiment of a color wheel for MD projection display according to the present invention;

FIG. 4 illustrates a second embodiment of the color wheel for MD projection display according to the present invention;

FIG. 5 illustrates a third embodiment of the color wheel for MD projection display according to the present invention;

FIG. 6 is a block diagram illustrating a fourth embodiment of the color wheel for MD projection display according to the present invention;

FIG. 7 illustrates a fifth embodiment of the color wheel for MD projection display according to the present invention;

FIG. 8 illustrates a sixth embodiment of the color wheel for MD projection display according to the present invention; and

FIG. 9 is a block diagram illustrating a seventh embodiment of the color wheel for MD projection display according to the present invention.

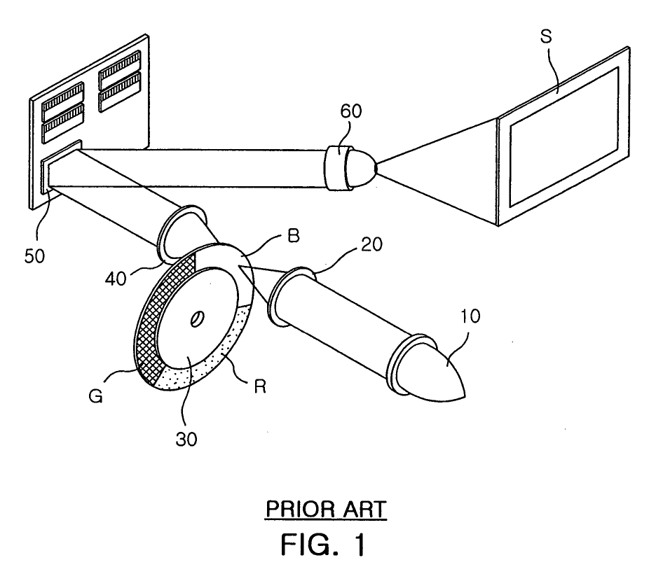

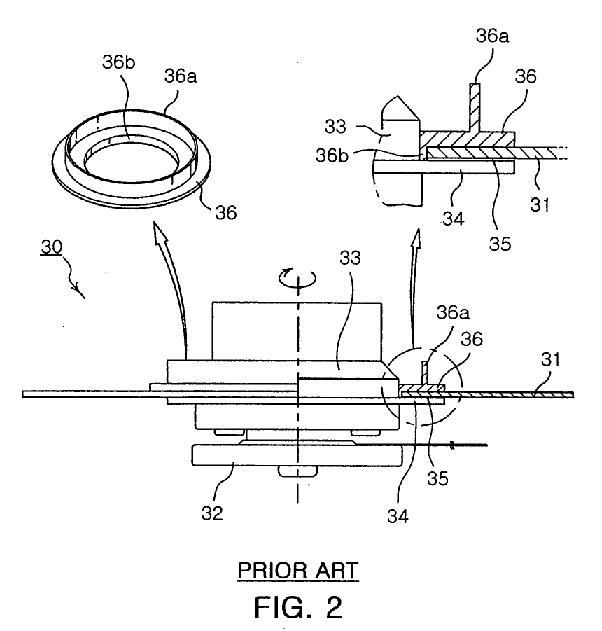

### DETAILED DESCRIPTION OF THE PREFERRED EMBODIMENT

Preferred embodiments of the present invention will now be described in detail with reference to the accompanying drawings.

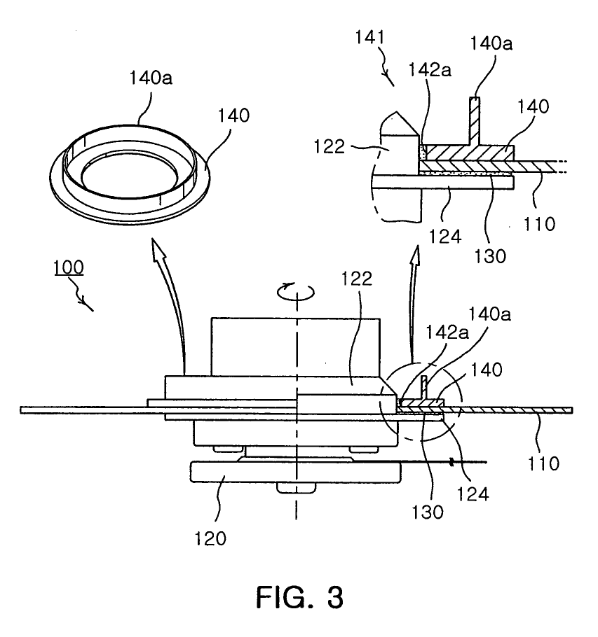

FIG. 3 is a block diagram illustrating a first embodiment of a color wheel for MD projection display according to the present invention. The color wheel 100 of the present invention, used in an optical engine for MD projection display to impart a plurality of colors to white light projected along an optical axis, includes a color filter 110, a driving motor 120, a filter adhesion layer 130, and a holder 140.

The color filter 110 is a disc-shaped rotary member on which red R, green G, and blue B colors are divided on the circumference thereof to impart colors to white light.

The driving motor 120 is driving means which provides driving source for rotating a rotor 122 at a high speed about an axis in parallel with the optical axis when power is applied. In order to fix the color filter to the rotor 122, a carrier 124 in a hollow disc-shape is assembled into the cylindrical rotor 122 or is formed integrally with the cylindrical rotor 122.

In addition, a filter adhesion layer 130, which provides a predetermined intensity of adhesive force for fixing the color filter to the carrier 124, is disposed between an upper surface of the carrier 124 and a lower surface of the color filter with an adhesive evenly applied on the adhesion area overlapped by the carrier 124 and the color filter 110.

The adhesive used for the filter adhesion layer 130 includes resin such as epoxy resin in order to obtain stable adhesive force at the adhesion area between the color filter 110 made of glass and the carrier 124 made of hard material.

In the meantime, the holder 140 is a stationary member assembled into the rotor 122 with a lower surface of the holder 140 in contact with an upper surface of the color filter 110 through the medium of the filter adhesion layer 130 on the carrier 124.

The holder 140 has a fixing part 141 at an inner surface thereof corresponding to an outer surface of the rotor 122 in order to provide compressive stress which offsets the tensile stress generated at the filter adhesion layer 130. The holder 140 is fixed integrally and firmly to the rotor 122 by the fixing part 141.

With the carrier having a disc-shaped body with a through hole formed in the center thereof inserted in the rotor 122, a predetermined intensity of external force is applied perpendicular to the filter adhesion layer 130 to pressure the holder 140 having an annular upper protrusion 140a on the upper surface thereof. Then, a compressive stress pressing toward the center of the section surface of the filter adhesion layer 130, in the opposite direction to a tensile stress working both opposite directions from the center of the section surface of the filter adhesion layer 130, is generated at the filter adhesion layer 130 between the color filter 110 and the carrier 124.

In addition, when the compressive force generated at the filter adhesion layer 130 reaches a pre-set value, the pressure at the holder 140 applied toward the filter adhesion layer 130 by external force can be maintained at a fixed level by fixing the holder 140 to an outer surface of the rotor 122 through the medium of the fixing part 141.

At this time, it is preferable that the compressive force applied to the filter adhesion layer 130 between the color filter 110 and the carrier 124 is evenly distributed in the entire adhesion area. Also, it is preferable that the intensity of the compressive stress generated at the filter adhesion layer 130 is set greater than that of the tensile stress generated at the filter adhesion layer 130 when there is no compressive force applied, and less than the breaking strength of the color filter, so as not to damage the color filter 110 made of glass by excessive compression.

As shown in FIG. 3, this embodiment includes a holder adhesion layer 142 formed with an adhesive applied in the space between an outer surface of the rotor 122 and a corresponding inner surface of the holder 140 provided with the fixing part, which provides fixing force for maintaining the pressure at the holder applied in the direction of optical axis by external force to generate compressive stress at the filter adhesion layer 130.

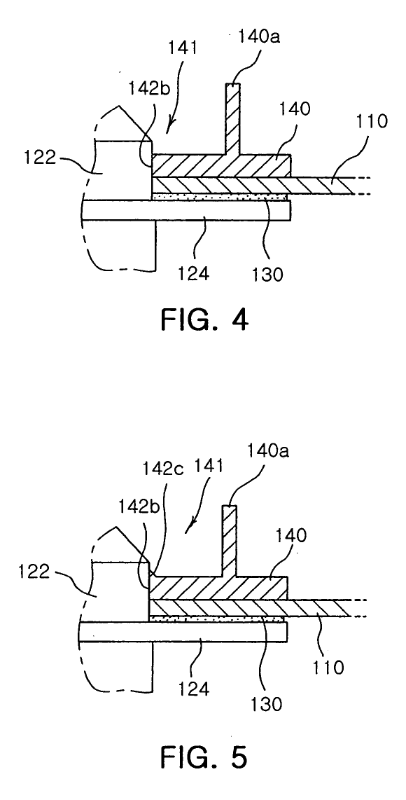

In a second embodiment, as shown in FIG. 4, the fixing part, which provides fixing force for fixing the holder 140, is constituted by hot insertion plate surface 142a which is inserted into the rotor 122 to contact an upper surface of the color filter 110 when expanded in volume by the heat applied to its hollow disc-shaped body, and then tightly fitted to an outer surface of the rotor 122 as it is cooled and constricted in volume.

Alternatively, in a third embodiment, as shown in FIG. 5, the fixing part which provides fixing force for maintaining the state of the holder 140 being compressed in the direction of the optical axis by external force and is inserted into the rotor 122 to contact an upper surface of the color filter 110, may have a caulked part 142c which extends along an outer surface of the rotor 122 to have a large contact surface at an inner surface of the holder 140 corresponding to an outer surface of the rotor 122.

In this case, the filter adhesion layer 130 is formed with an adhesive applied in the overlapping region of the color filter 110 and the carrier 124 to fix the color filter 110 to the carrier 124. Then, the carrier 124 with the color filter 110 adhered thereto is inserted into the rotor 122 of the driving motor 120. Then, the holder 140 is inserted into the rotor 122, pressed toward the filter adhesion layer 130 to generate compressive stress.

At this time, with the compressive stress, due to the compressive force, in the range of intensity set greater than the tensile stress generated at the filter adhesion layer 130 and less than breaking strength of the color filter 110, the pressure is maintained at the holder 140 by the fixing part 141 such as the holder adhesion layer 142a, the hot insertion plate surface 142b and the caulked part 142c. Thereby, the tensile stress generated at the filter adhesion layer 130 during the rotation of the color filter 110 is offset by the compressive stress generated at the filter adhesion layer 130 to be eliminated or minimized, increasing the intensity of the adhesive force at the filter adhesion layer 130.

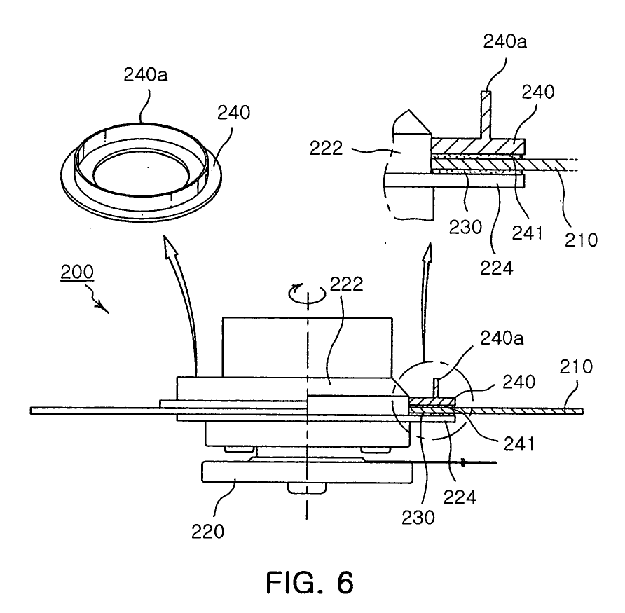

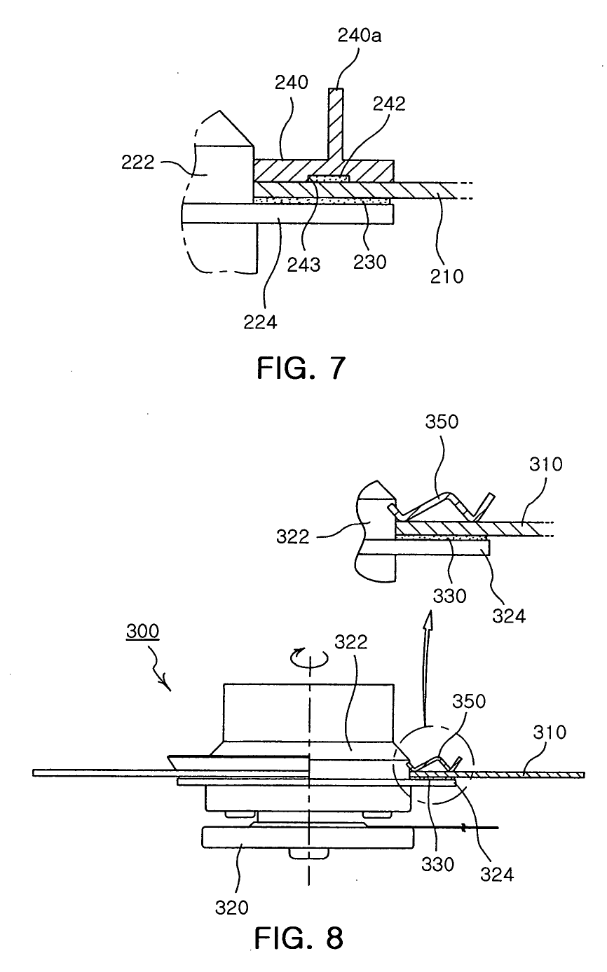

FIG. 6 is a block diagram illustrating a fourth embodiment of the color wheel for MD projection display according to of the present invention, and FIG. 7 illustrates a fifth embodiment with a principal part of the color wheel for MD projection display according to the present invention.

As shown in FIGS. 6 and 7, the color wheel 200 includes a color filter 210, a driving motor 220, a filter adhesion layer 230, and a holder 240, same as in the color wheel 100 of the first, second, and third embodiments. The same components are designated with the same numbers but in the 200s. The detailed explanation for each component is omitted.

In this embodiment, a holder adhesion layer 241 is provided in the interface between the color filter 210 and the holder in a hollow disc-shaped body inserted into the rotor 222 of the driving motor 220 in order for the tensile stresses of opposite directions to be simultaneously generated at upper and lower surfaces of the color filter, offsetting each other to be eliminated altogether.

Here, it is preferable that the holder adhesion layer 241 has the same area and thickness as the filter adhesion layer 230 and is made of the same material as the adhesive of the filter adhesion layer 230 so as to generate another tensile stress corresponding to the tensile stress generated at the filter adhesion layer 230.

In addition, in a fifth embodiment, the holder adhesion layer 241 may include at least one upper groove 242 depressed on a lower surface of the holder corresponding to an upper surface of the color filter 210, and an adhesive 243 filled in the upper groove 242.

In this case, in the overlapping region of the color filter 210 and the carrier 224, the filter adhesion layer 230 is formed with an adhesive applied thereon to fix the color filter 210 to the carrier 224, and then, the carrier 224 with the color filter 210 adhered thereto is inserted into the rotor 222 of the driving motor 220.

In addition, on an upper surface of the color filter 210, an adhesive made of the same material as the adhesive constituting the filter adhesion layer 230 is applied, and then the holder 240 having an upper protrusion 240a is inserted into the rotor 222 to be deposited on the color filter 210. Thereby, the holder 240 is inserted into the rotor 222 to be fixed in its position by the holder adhesion layer 241 formed between the color filter 210 and the holder 240.

In this state, as the color filter 210 is rotated by the driving motor 220, the tensile stress generated at the filter adhesion layer 230 is offset to be eliminated or minimized by the tensile stress generated at the holder adhesion layer 241, thereby increasing the adhesive force at the filter and holder adhesion layers 230 and 241.

FIG. 8 illustrates a sixth embodiment of the color wheel for MD projection display according to the present invention. As shown in FIG. 8, the color wheel 300 of the present invention includes a color filter 310, a driving motor 320, and a filter adhesion layer 330 as in the first, second, third, fourth, and fifth embodiments, which are designated with the same numbers in the 300s.

This embodiment includes at least one spring member 350 for providing the filter adhesion layer 330 with the compressive stress which can offset the tensile stress generated at the filter adhesion layer 330.

As shown in FIG. 8, the spring member 350 is made of resilient material, with one end fixed to an outer surface of the driving motor 320 and the other end resiliently contacting an upper surface of the color filter 310. Thereby, the spring member 350 provides resilient force to apply a predetermined intensity of compressive force through the color filter 310 to the filter adhesion layer 330.

Here, it is preferable that the plurality of spring members 350 with each one end fixed to the rotor 322 are arranged bilaterally symmetrical about the rotational axis of the rotor 322 in order to apply the compressive force evenly to the entire area of the filter adhesion layer 330.

In addition, it is preferable that the other end of the spring member 350 which has one end fixed to the rotor 322 is in surface contact with an upper surface of the color filter in order to prevent damage to the color filter 310 made of glass.

In this case, with the carrier 324 having the color filter 310 adhered thereto through the medium of the filter adhesion layer 330 inserted into the rotor 322 of the driving motor 320, as the other end of the spring member with one end fixed to an outer surface of the rotor 322 resiliently contacts an upper surface of the color filter 310, compressive force is transmitted to the filter adhesion layer 330 through the color filter 310. Thereby, the tensile stress generated at the filter adhesion layer 330 during the rotation of the color filter 310 is offset or minimized by the compressive force from the spring member 350, increasing the intensity of the adhesive force at the filter adhesion layer 330.

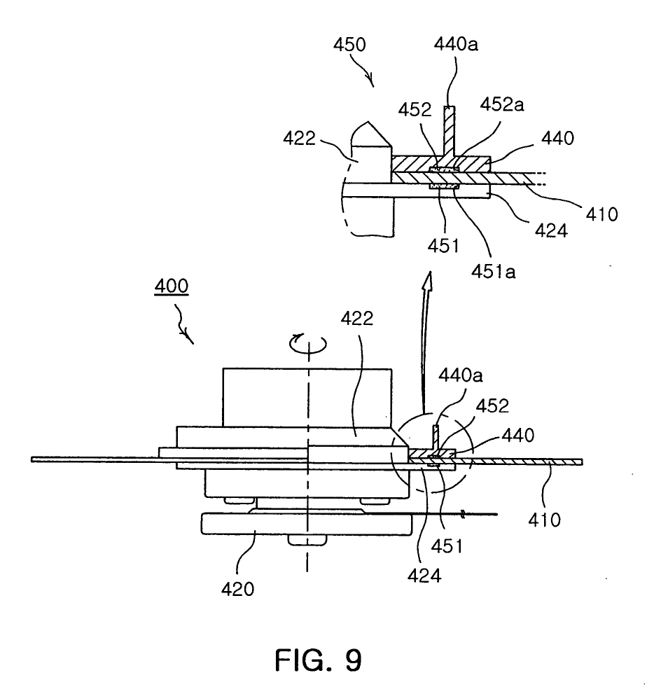

FIG. 9 illustrates a seventh embodiment of the color wheel for MD projection display according to the present invention. As shown in FIG. 9, the color wheel 400 of the present invention includes a color filter 410, a driving motor 420, and a holder 440, same as in the color wheel of the first, second, third, fourth, fifth, and sixth embodiments, which are designated with the same numbers in the 400s.

The holder 440 is a stationary member which is inserted into the rotor 422 of the driving motor 420 to have a lower surface thereof in contact with an upper surface of the color filter 410, thereby fixed to an outer surface of the rotor 422 of the driving motor 420.

In addition, a friction part 450, provided in this embodiment to fix the color filter 410 by friction force, includes a lower friction material 451 and an upper friction material 452.

The lower friction material 451 is provided in an interface between an upper surface of the carrier 424 assembled into the rotor 422 and a lower surface of the color filter 410. The upper friction material 452 is provided in an interface between an upper surface of the color filter 410 and a lower surface of the holder 440.

Here, it is preferable that the upper friction material 452 is provided in at least one upper groove 452a depressed on a lower surface of the holder 440 corresponding to the color filter 410. It is also preferable that the lower friction material 451 is provided in at least one lower groove 451a depressed on an upper surface of the carrier 424 corresponding to a lower surface of the color filter 410.

In addition, the upper and lower friction materials 451 and 452 are positioned on the same vertical line to vertically overlap each other so as to maximize the friction force on upper and lower surfaces of the color filter 410 made of glass.

Moreover, it is preferable that the upper and lower friction materials 451 and 452 are provided, respectively, in entire areas of the overlapped regions of an upper surface of the color filter 410 and a lower surface of the holder 440, and of a lower surface of the color filter 410 and an upper surface of the carrier so as to maximize the friction force at upper and lower surfaces of the color filter 410.

Here, it is more preferable that the upper and lower friction materials 451 and 452 are made of rubber in order to generate high intensity of friction force at contact surfaces with the color filter 410.

As the carrier 424 with the lower friction material 451 made of rubber in the lower groove 451a depressed on an upper surface thereof is inserted into the rotor 422 of the driving motor 420 to be fixed in the position thereof, the color filter 410 is also inserted into the rotor 422 to be deposited on an upper surface of the carrier 424.

As the holder 440 with the upper friction material 452 made of rubber in the upper groove 452a is inserted into the rotor 422 to be in contact with an upper surface of the color filter 410, pressure is applied to the holder 440 to compress the upper and lower friction materials 451 and 452 so as to generate a predetermined or greater intensity of friction force between the upper and lower friction materials 451 and 452 and upper and lower surfaces of the color filter 410. Further, in order to maintain the compressive force for a long time, the holder 440 is integrally fixed to the rotor 422 of the driving motor 420.

Accordingly, the color filter 410 is prevented from slipping and firmly fixed in the position thereof between the carrier 424 and the holder 440 by the friction force respectively generated at upper and lower surfaces of the color filter 410 corresponding to the friction part 450 during the rotation of the color filter 410.

In the present invention as set forth above, a fixing part is provided at an inner surface corresponding to an outer surface of the rotor or a spring member is provided to apply pressure to the color filter, maintaining the compressive force applied through the color filter to the filter adhesion layer. Therefore, the tensile stress generated at the filter adhesion layer is offset by the compressive stress, enhancing the intensity of adhesive force at the filter adhesion layer, thereby extending the life time of the color wheel operating at high temperature and speed.

Moreover, the present invention utilizes a bilateral adhesion structure in which adhesion layers are formed respectively on upper and lower surfaces, generating tensile stresses of opposite directions which offset each other to improve the adhesive strength at the filter adhesion layer, thereby extending the life time of the color wheel operating at high temperature and speed.

Furthermore, as the color filter is fixed in the position thereof between the holder and the carrier by friction force generated through the friction part, the color filter can be firmly fixed to the driving motor, enhancing productivity in assembly.

While the present invention has been shown and described in connection with the preferred embodiments, it will be apparent to those skilled in the art that modifications and variations can be made without departing from the spirit and scope of the invention as defined by the appended claims.

What is claimed is:

1. A color wheel for Micro-Device (MD) projection display, used in an optical engine to impart a plurality of colors to white light projected along an optical axis, comprising:
a color filter with a plurality of colors divided on the circumference thereof;
a driving motor providing driving source to rotate a rotor with the color filter assembled thereinto, about a rotational axis in parallel with the optical axis;
a filter adhesion layer having an adhesive applied to an adhesion surface where a carrier assembled into the rotor overlaps with the color filter placed thereon, so as to provide adhesive force for fixing the color filter to the carrier; and
a holder having a fixing part in an inner surface thereof corresponding to an outer surface of the rotor in order to maintain compressive force owing to a predetermined intensity of external force applied to the filter adhesion layer through the color filter, thereby imparting a compressive stress which offsets a tensile stress generated at the filter adhesion layer.

2. The color wheel for MD projection display according to claim 1, wherein the intensity of the compressive stress is set greater than the tensile stress generated at the filter adhesion layer when there is no compressive force applied and less than breaking strength of the color filter.

3. The color wheel for MD projection display according to claim 1, wherein the fixing part comprises a holder adhesion layer formed by an adhesive applied between an outer surface of the rotor and a corresponding inner surface of the holder.

4. The color wheel for MD projection display according to claim 1, wherein the fixing part comprises a hot insertion plate surface which is press-fitted into an outer surface of the rotor while hot so as to be fixed to an outer surface of the rotor when cooled.

5. The color wheel for MD projection display according to claim 1, wherein the fixing part comprises a caulked part extending along an outer surface of the rotor to have a large contact surface on an inner surface thereof corresponding to an outer surface of the rotor.

6. A color wheel for Micro-Device (MD) projection display, used in an optical engine to impart a plurality of colors to white light projected along an optical axis, comprising:
a color filter with a plurality of colors divided on the circumference thereof;
a driving motor providing driving source to rotate a rotor with the color filter assembled thereinto, about a rotational axis in parallel with the optical axis;
a filter adhesion layer having an adhesive applied to an adhesion surface where a carrier assembled into the rotor overlaps with the color filter placed thereon, so as to provide adhesive force for fixing the color filter to the carrier; and
a holder assembled into the rotor having a holder adhesion layer provided on an interface between the holder and the color filter so as to generate tensile stresses in opposite directions to that generated between the color filter and the filter adhesion layer, thereby offsetting the tensile stresses generated at upper and lower surfaces of the color filter.

7. The color wheel for MD projection display according to claim 6, wherein the holder adhesion layer comprises an adhesion area having the same size as that of the filter adhesion layer.

8. The color wheel for MD projection display according to claim 6, wherein the holder adhesion layer comprises at least one upper groove depressed in a lower surface of the holder corresponding to an upper surface of the color filter, and an adhesive filled in the upper groove.

9. A color wheel for Micro-Device (MD) projection display, used in an optical engine to impart a plurality of colors to white light projected along an optical axis, comprising:
a color filter with a plurality of colors divided on the circumference thereof;
a driving motor providing driving source to rotate the rotor with the color filter assembled thereinto, about a rotational axis in parallel with the optical axis;
a filter adhesion layer including an adhesive applied to an adhesion surface where a carrier assembled into the rotor overlaps with the color filter placed thereon, so as to provide adhesive force for fixing the color filter to the carrier; and
at least one spring member with one end fixed to the outer surface of the rotor to apply compressive force to the filter adhesion layer through the color filter, and the other end resiliently contacting an upper surface of the color filter to provide the filter adhesion layer with a compressive stress which offsets a tensile stress generated at the filter adhesion layer.

10. The color wheel for MD projection display according to claim 9, wherein the spring members are arranged bilaterally symmetrical about the axis of the rotor.

11. The color wheel for MD projection display according to claim 9, wherein the other end of the spring member is in surface contact with an upper surface of the color filter.

12. The color wheel for. MD projection display according to claim 9, wherein the other end of the spring member is positioned within the overlapping region of the color filter and the carrier.

13. A color wheel for Micro-Device (MD) projection display, used in an optical engine to impart a plurality of colors to white light projected along an optical axis, comprising:
a color filter with a plurality of colors divided on the circumference thereof;
a driving motor providing driving source to rotate a rotor with the color filter assembled thereinto, about a rotational axis in parallel with the optical axis;
a holder fixed to the rotor to have a lower surface thereof in contact with an upper surface of the color filter; and
a friction part for fixing the color filter to the rotor, by friction force, including a lower friction material provided in an interface between the color filter and the carrier assembled into the rotor, and an upper friction material provided in an interface between the color filter and the holder.

14. The color wheel for MD projection display according to claim 13, wherein the upper friction material is provided in at least one upper groove depressed on a lower surface of the holder corresponding to an upper surface of the color filter, and the lower friction material is provided in at least one lower groove depressed on an upper surface of the carrier corresponding to a lower surface of the color filter.

15. The color wheel for MD projection display according to claim 13, wherein the upper and lower friction materials are positioned on the same horizontal line, overlapping each other vertically.

16. The color wheel for MD projection display according to claim 13, wherein the upper and lower friction materials are provided in the entire areas of the overlapping regions of an upper surface of the color filter and a lower surface of the holder, and of a lower surface of the color filter and an upper surface of the carrier.

17. The color wheel for MD projection display according to claim 13, wherein the upper and lower friction materials are made of rubber.
